(19) United States
(12) Patent Application Publication
(10) Pub. No.: US 2009/0150898 A1
(43) Pub. Date: Jun. 11, 2009

(54) MULTITHREADING FRAMEWORK SUPPORTING DYNAMIC LOAD BALANCING AND MULTITHREAD PROCESSING METHOD USING THE SAME

(75) Inventors: Kang Min Sohn, Daejeon (KR); Yong Nam Chung, Daejeon (KR); Seong Won Ryu, Daejeon (KR); Chang Joon Park, Daejeon (KR); Kwang Ho Yang, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/266,673

(22) Filed: Nov. 7, 2008

(30) Foreign Application Priority Data
Dec. 11, 2007 (KR) 10-2007-0128076

(51) Int. Cl. G06F 9/46

(52) U.S. Cl. 718/105

(57) ABSTRACT

A multithreading framework supporting dynamic load balancing, the multithreading framework being used to perform multi-thread programming, the multithreading framework includes a job scheduler for performing parallel processing by redefining a processing order of one or more unit jobs, transmitted from a predetermined application, based on unit job information included in the respective unit jobs, and transmitting the unit jobs to a thread pool based on the redefined processing order, a device enumerator for detecting a device in which the predetermined application is executed and defining resources used inside the application, a resource manager for managing the resources related to the predetermined application executed using the job scheduler or the device enumerator, and a plug-in manager for managing a plurality of modules which performs various types of functions related to the predetermined application in a plug-in manner, and providing such plug-in modules to the job scheduler.

### CROSS-REFERENCE(S) TO RELATED APPLICATIONS

The present invention claims priority of Korean Patent Application No. 10-2007-0128076, filed on Dec. 11, 2007, which is incorporated herein by reference.

### FIELD OF THE INVENTION

The present invention relates to a multithreading framework, and, in more particular, to a multithreading framework supporting dynamic load balancing, which is suitable for supporting dynamic load balancing in a multi-core process environment including a single core process, and a multithread processing method using the same.

This work was supported by the IT R&D program of MIC/IITA[2006-S-044-02, Development of Multi-Core CPU & MPU-Based Cross-Platform Game Technology]

### BACKGROUND OF THE INVENTION

As well known, with the development of technology in the computer field, the case in which a plurality of tasks must be simultaneously performed frequently occurs as well as the case in which a single task is performed. For example, there is a case in which input through a keyboard, output through a monitor, input/output over a network and the storage of a file must be simultaneously processed. The simultaneous processing of a plurality of tasks, including such multi-input/output processing, is called multiprocessing.

Multiprocessing is implemented by the methods of multitasking and multiplexing. Multitasking means that a plurality of tasks is divided and processed in a plurality of processes (or threads), and multiplexing means that a plurality of tasks is processed in a single process.

In particular, multitasking is a process for simultaneously processing a plurality of tasks, and for implementing multitasking an Operating System (OS) uses a method of executing a plurality of processes (multi-process) for multiprocessing or a method of executing a plurality of threads (multi-thread).

Here, in multiprocessing, a number of processes, corresponding to the number of tasks that must be processed independently, are created, and then the tasks are performed. Although multiprocessing has an advantage in that respective processes independently process the tasks, so that multiprocessing can be simply implemented, it has disadvantages in that a number of processes, corresponding to the number of the tasks on which parallel processing must be performed, must be created, in that memory usage increases as the number of the processes to be created increases, and in that the frequency of process scheduling increases, so that the performance of a program handling the tasks is lowered. Since communication between processes should be performed with the help of an operating system in order to share data between the processes, multiprocessing has another problem in that the implementation of the program is complex.

In contrast, multithreading means that tasks are independently performed in a single process while multiprocessing means that processes are independently excuted. When a plurality of threads is performed in a process, each of the threads is treated as a single process when viewed from the outside. When a thread is created in a specific process, the newly created thread does not duplicate the image of the original process, but shares the image of the original process. Since threads created in an identical process share an image region except their own stacks, multithreading has advantages in that the capacity of memory necessary to create a thread is relatively lower than the capacity of memory necessary to create a process, in that the time required to create a thread is very short (several tens of times faster than the time required to create a process), and in that the scheduling of threads is realized relatively faster than the scheduling of processes.

Meanwhile, there is a prior art for performing dynamic allocation for multi-thread computer resources, discloses a device, program product and method for dynamically allocating threads to multi-thread computer resources, including a plurality of physical sub-systems, based on a related specific type. There is another prior art discloses the technical spirit in which thread types are allocated to resources existing in identical physical sub-systems of a computer, respectively, and thus newly created threads and/or recycled threads corresponding to one of specific thread types are dynamically allocated to one of resources, allocated to said one of the specific threads types, with the result that threads which have the same type are generally allocated to computer resources existing in the identical physical sub-system of the computer, so that mutual traffic between the plurality of physical sub-systems existing in the computer is reduced.

Further, there is a prior art for scheduling threads in a multi-core structure, discloses a method and device for scheduling threads in a multi-core processor. It discloses the technical spirit in which executable transactions are scheduled using one or more distribution queues and a multi-level scheduler, such a distribution queue enumerates an executable list in the order of suitability for execution, the multi-level scheduler includes a plurality of linked transaction schedulers which can be individually executed, each of the transaction schedulers includes a scheduling algorithm used to determine an executable transaction that is the most suitable for execution, and the executable transaction that is the most suitable for execution is output from the multi-level scheduler to the one or more distribution queues.

As described above, the prior art technique related to a method of minimizing communication between processors by minimizing to allocate resources, which are included in a single processor, to another processor, in a multiprocessor environment, and the prior art technique related to a method of solving problems caused in scheduling used to allocate threads in multi-core structures. However, since, for example, 3-Dimensional (3D) online game fields, which should use maximum hardware resources, are optimized to single thread-based programming, the prior art techniques act as a factor which lowers the performance of the operation of the program, optimized to single thread-based environment, in a multi-core environment.

### SUMMARY OF THE INVENTION

It is, therefore, an object of the present invention to provide a multithreading framework supporting dynamic load balancing, which can improve the performance of the multi-core processor, and can also be applied to a single processor and a multi-core processor and perform multi-thread programming, and a multithread processing method using the same.

Another object of the present invention is to provide a multithreading framework supporting dynamic load balancing, which not only enables necessary functions to be added or removed in a plug-in basis, but also can develop an application program in a parallel processing basis regardless of the number of cores by using a dynamic load balancing function, and a multithread processing method using the same.

In accordance with one aspect of the invention, a multithreading framework supporting dynamic load balancing, the multithreading framework being used to perform multi-thread programming, the multithreading framework includes a job scheduler for performing parallel processing by redefining a processing order of one or more unit jobs, transmitted from a predetermined application, based on unit job information included in the respective unit jobs, and transmitting the unit jobs to a thread pool based on the redefined processing order, a device enumerator for detecting a device in which the predetermined application is executed and defining resources used inside the application, a resource manager for managing the resources related to the predetermined application executed using the job scheduler or the device enumerator, and a plug-in manager for managing a plurality of modules which performs various types of functions related to the predetermined application in a plug-in manner, and providing such plug-in modules to the job scheduler. The multithreading framework further includes a memory manager for performing memory management in order to prevent memory-related problems, including memory fragmentation of the multithreading framework. The predetermined application is used in a state of being overridden in a virtual function form in the multithreading framework by using written game code, and is configured to perform functions related to initialization for various types of applications, update of input values, processing of the input values, update of status and termination, construct one or more desired unit jobs based thereon and provide the unit jobs to the job scheduler. The predetermined application includes an initialization unit for performing an initialization function for various types of applications which operate based on the multithreading framework, a game loop unit for updating an input value for each loop of the predetermined application, processing the updated input value based on the predetermined application, and performing update of status related to a game, a termination unit for, when the predetermined application is terminated, processing a termination process including cleaning garbage collection of memory and terminating network connection. The game loop unit includes an update input unit for updating the input values, including an input by a user and an input over a network at each loop of the predetermined application, a process input unit for processing the input values, collected by the update input unit, based on the application, and a game update unit for performing update of the status related to the game, including a game animation, a physical simulation, artificial intelligence update, and screen update for the predetermined application. The job scheduler performs a single thread mode or a multi-thread mode based on a number of cores of a platform. The job scheduler performs or cancels one of the unit jobs in the single thread mode by increasing or decreasing a runtime option level based on a predetermined frame rate, and comparing an option level of the corresponding unit job with the increased or decreased runtime option level. The job scheduler performs parallel processing in the multi-thread mode by performing checking whether the multithreading framework's operation termination signal exists, checking of validity of the unit job and storage of the input unit job while performing checking of a job queue, determination of whether one or more usable threads exist and job scheduling. The job scheduling is performed by increasing or decreasing capacity of the thread pool or increasing or decreasing the runtime option level based on a preset frame rate and Central Processing Unit (CPU) load, and then performing or canceling the unit job based on a result of comparing the option level and the runtime option level. The unit job comprises a global serial number, a local serial number, the option level, and defined job information. The plug-in module constructs a specific engine by implementing and allocating functions, used for the unit jobs, as a respective module. The plug-in module includes a plug-in for performing a function of rendering a polygon on a screen using a graphic library, including DirectX or OpenGL, for the predetermined application, a plug-in for performing a function of taking charge of physical simulation so as to perform realistic expression for the predetermined application, a plug-in for performing automatic control of a Non-Player Character (NPC) used in the predetermined application, a plug-in for performing a function of taking charge of providing one or more interfaces which enable configuration of the predetermined application to be modified from an outside without changing source code, and supporting various types of interfaces so as to use script languages, and a plug-in for defining additional functions for the predetermined application.

In accordance with another aspect of the invention, a multithread processing method using a multithreading framework supporting dynamic load balancing, the multithreading framework being used to perform multi-thread programming, the multithread processing method includes switching between a single thread mode and a multi-thread mode based on a number of cores of a platform of the multithreading framework, in a case of the single thread mode, increasing or decreasing a runtime option level based on a preset frame rate, and performing or canceling a unit job based on a result of comparing an option level of the corresponding unit job with the increased or decreased runtime option level, and in a case of the multi-thread mode, performing checking whether the multithreading framework's operation termination signal exists, checking whether input of a unit job exists, and storing the input unit job while checking a job queue, determination whether one or more usable threads exist, and performing job scheduling. The multithread processing method further includes, after the step of, in a case of the multi-thread mode, performing checking, increasing or decreasing a capacity of a thread pool based on the preset frame rate and CPU load, or increasing or decreasing the runtime option level, and performing or canceling the unit job based on the result of comparing the option level with the runtime option level. The step of switching includes if a predetermined application operates in an initialization mode of the multithreading framework, measuring a number of cores of a current platform, determining whether the measured number of cores of the current platform is greater than ‘1’, if the measured number of cores of the current platform is ‘1’, operating in the single thread mode, and if the measured number of cores of the current platform is greater than ‘1’, creating n−1 threads, excepting a main thread in which the predetermined application is being operated, in the thread pool, and then operating in the multi-thread mode. The step of increasing or decreasing the runtime option level, in the case of the single thread mode, includes increasing or decreasing the runtime option level based on the preset frame rate, and determining whether input of a unit job exists in a job queue of the multithreading framework, if the input of a unit job exists, comparing the option level of the corresponding unit job and the increased or decreased runtime option level, and if the option level of the unit job does not exceed the runtime option level, performing the unit job, and, if the option level of the unit job exceeds the runtime option level, canceling the unit job. The step of increasing or decreasing the runtime option level, in the case of the single thread mode, includes determining whether the frame rate of the multithreading framework is lower than the preset frame rate, if the frame rate is not lower than the preset frame rate and is maintained at a predetermined level, increasing the runtime option level, and if the frame rate is lower than the preset frame rate, decreasing the runtime option level. The step of performing checking, in a case of the multi-thread mode, includes determining whether a multithreading framework's operation termination signal exists, and, if no operation termination signal exists, determining whether input of the unit job exists, if no input of the unit job exists, determining whether the operation termination signal exists again, and, if the input of the unit job exists, storing the unit job in the job queue, determining whether a unit job to be performed exists in the job queue while performing the step of determining whether the multithreading framework's operation termination signal exists and the step of if no input of the unit job exists, determining whether the operation termination signal exists again, if a unit job to be performed exists in the job queue, determining whether a usable idle thread exists in the thread pool, and if a usable idle thread exists in the thread pool, performing job scheduling using the idle thread. The step of increasing or decreasing the capacity of the thread pool includes if the frame rate of the multithreading framework is lower than a preset frame rate, determining whether CPU load capacity of the multithreading framework has idle resource, if the CPU load capacity does not have idle resource, determining whether capacity of the thread pool exceeds ‘an initially set core number−1’, if the capacity of the thread pool does not exceed the ‘initially set core number−1’, decreasing the runtime option level, if the capacity of the thread pool exceeds the ‘initially set core number−1’, decreasing the capacity of the thread pool, if the CPU load capacity has idle resource, increasing the capacity of the thread pool, if the frame rate is not lower than the preset frame rate and is maintained at a predetermined level, selectively increasing the runtime option level only when the CPU load capacity has idle resource, and performing or canceling the unit job based on a result of comparing the option level with the increased or decreased runtime option level. The step of performing of canceling the unit job includes adjusting the capacity of the thread pool and the runtime option level, and then extracting the unit job stored in the job queue, determining whether the option level of the extracted unit job exceeds the runtime option level, if the option level of the extracted unit job does not exceed the runtime option level, allocating the unit job to an idle thread so that the unit job is performed, and if the option level of the extracted unit job exceeds the runtime option level, canceling the unit job.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram showing the configuration of a multithreading framework supporting dynamic load balancing in accordance with an embodiment of the present invention;

FIG. 2 is a flowchart showing a process of initializing the multithreading framework in accordance with the present invention;

FIG. 3 is a flowchart showing a process of performing the single thread mode of the multithreading framework in accordance with the present invention;

FIG. 4 is a flowchart showing a process of performing the multithreading mode of the multithreading framework in accordance with the present invention;

FIG. 5 is a flowchart showing a process of performing the task scheduling mode of the multithreading framework in accordance with the present invention;

FIG. 6 is a view showing the configuration of the unit of a task and task scheduling in the multithreading framework in accordance with the present invention; and

FIGS. 7 and 8 are a view showing the comparison of the multithreading framework in accordance with the present invention and a general multi-thread programming model.

### DETAILED DESCRIPTION OF THE PREFERRED EMBODIMENTS

The gist of the present invention is to perform unit jobs in a single thread mode or in a multi-thread mode using a multithreading framework, including a job scheduler for performing parallel processing, by redefining the processing order of unit jobs, transmitted from a predetermined application based on unit job information included in the respective unit jobs, and transmitting the unit jobs to a thread pool based on the redefined processing order. The problems of the prior art can be solved through the technical means.

Hereinafter, preferred embodiments of the present invention will be described in detail with reference to the accompanying drawings.

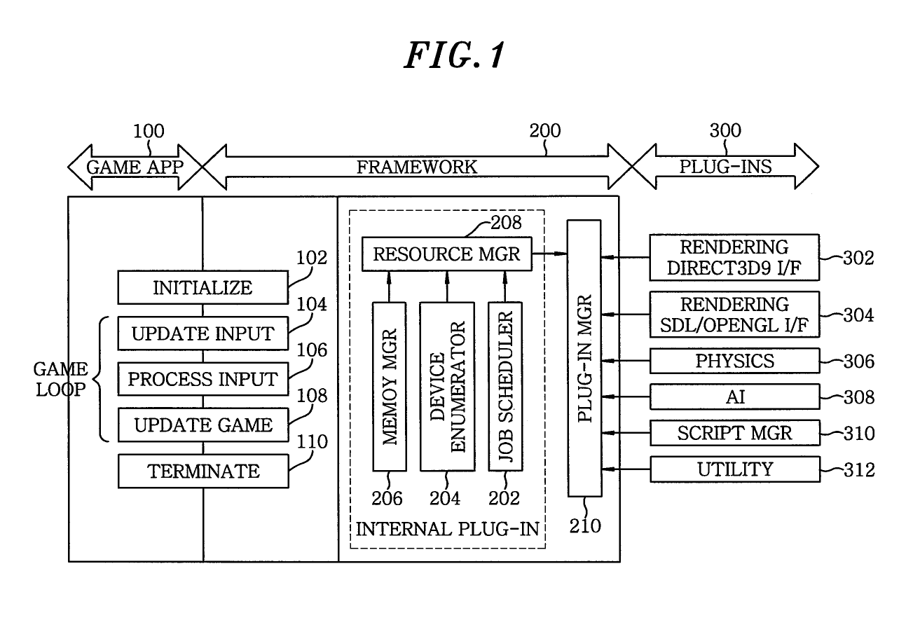

FIG. 1 is a diagram showing the configuration of a multithreading framework supporting dynamic load balancing in accordance with an embodiment of the present invention. The multithreading framework includes a game application unit (Game App) 100, a framework unit (Framework) 200, and a plug-in unit (Plug-Ins) 300.

With reference to FIG. 1, the game application unit 100 includes an initialization unit (Initialize) 102, an update input unit (Update Input) 104, a process input unit 106, a game update unit (Update Game) 108, and a termination unit (Terminate) 110. The game application unit 100 is used by overwriting a desired function, as the form of a virtual function in the basic structure of the framework using game code written by a user. When the basic function of the framework is used, the game application unit 100 performs a function of calling the method of a super (or parent) class from the overridden function.

Here, the initialization unit 102 performs various types of initialization functions necessary for an application which operates based on the multithreading framework. The update input unit 104 is included in a game loop and performs a function of updating an input value, such as the input of a user or input over a network, for each loop. The process input unit 106 performs a function of processing the input value, collected by the update input unit 104, based on the application. The game update unit 108 performs a function of updating a status related to a game, such as the update of game animation, physical simulation, or artificial intelligence, and screen update. When the performance of a specific application is terminated, the termination unit 110 performs a termination process, such as cleaning garbage collection of memory and terminating network access. Such execution modules configure one or more jobs, which require parallelization, in the form of unit jobs, and then transmit them to the job scheduler 202. The job scheduler 202 transmits the corresponding jobs to a thread pool and then performs parallel processing for the corresponding jobs. Here, the state of the thread pool can be expressed as the number of threads existing in a current thread pool except main thread, in which a specific application is currently operating, and the number of threads existing in a current thread pool is not greater than the number of cores of a current Central Processing Unit (CPU). For example, in the case of a dual-core CPU, the number of cores (n) is ‘2’ and the number of thread pools is ‘1’. Meanwhile, a number of threads greater than the number of cores of a CPU can be used depending on the character or status of a processor or an application to which Simultaneous Multi-Threading (SMT) technology, such as Hyper-Threading Technology (HTT), is applied.

Further, the framework unit 200 includes a job scheduler 202, a device enumerator 204, a memory manager (Memory Mgr) 206, a resource manager (Resource Mgr) 208, and a plug-in manager (Plug-In Mgr) 210. The framework unit 200 performs a multithread function for parallel processing, provides, for example, a basic game loop necessary to develop a game, performs thread management in a thread pool manner, defines a unit job for a module which requires parallel processing, and then performs a corresponding unit job by allocating the unit job to a thread in an idle state.

Here, the job scheduler 202 receives unit jobs generated by the respective execution modules of the game application unit 100, redefine the processing order of the unit jobs using unit job information (for example, a global serial number, a local serial number, an option level, and defined job information) included in the unit jobs. And the job scheduler 202 transmits the unit jobs to the thread pool based on the redefined processing order to perform the unit job in parallel.

The option level of the unit job information is set such that a unit job which is essential to the progress of a game, when a game application is executed, is ‘1’, and such that a unit job which does not affect the progress of a game has a value which is relatively greater than ‘1’. Dynamic load balancing can be implemented by comparing the option level with the runtime option level (a specific threshold value) of the job scheduler 202 and performing no job in which the option level thereof exceeds the runtime option level. The value of an intermediate option level can be adjusted using a trial and error method so as to be appropriate to the characters of a game.

For example, in the case in which a developer sets five option levels when developing a game application, a unit job (for example, vertexes, a basic texture, basic shadows, and animations which configure a 3D screen) which is essentially required to progress a game is set to ‘1’, and a unit job (for example, a magnificent texture, complex shadows, particles for special effects, and weather effects) which does not affect the progress of the game but is necessary to express magnificent effects is set to ‘5’. Thereafter, when the game is executed, a operation condition is set to ‘3’ in the framework, the runtime option level is dynamically updated in consideration of a number of Frames Per Second (FPS) and the usage rate of a CPU for every frame, the runtime option level is compared with the option level of a unit job transmitted to the job scheduler 202, and the performance of the unit job which has an option level, is greater than the runtime option level, is canceled.

The device enumerator 204 performs a function of detecting one or more devices (for example, a network card, a video card, memory size, the type and number of CPUs, and a physical acceleration device) which can be utilized in hardware in which an application is executed, and defining them as resources that can be utilized inside the application.

Further, the memory manager 206 performs memory management so as to prevent memory-related problems, such as a memory fragmentation, in the game application unit 100. The resource manager 208 performs a function of managing various types of hardware resources detected by the device enumerator 204 and game-related resources (for example, text, vertexes, animation data and etc.) used in the game application unit 100, and the plug-in manager 210 performs a function of managing the managers which perform various types of functions in the form of plug-ins (for example, a function of mounting, configuring, and removing plug-ins).

Meanwhile, the plug-in unit 300 includes rendering units (Rendering) 302 and 304, a physical unit (Physics) 306, an Artificial Intelligence (AI) unit (Artificial Intelligence) 308, a script manager (Script Mgr) 310, and a utility unit (Utility) 312. The plug-in unit 300 implements the functions used in the framework unit 200 for respective modules, allocates necessary functions, and then configures, for example, a desired game engine.

Here, the rendering units 302 and 304 are plug-ins for performing a function of rendering a polygon on a screen through a graphic library, such as DirectX or OpenGL. The physical unit 306 is a plug-in for taking charge of a physical simulation for a realistic expression. The AI unit 308 is a plug-in for performing the automatic control of a Non-Player Character (NPC) used in the game application unit 100. The script manager 310 is a plug-in for performing a function of providing an interface which can change the configuration of the game application unit 100 from outside without modifying the source code of the game application unit 100. The script manager 310 is an element which supports various types of interfaces so as to use script languages, such as Lua, Python, and Rudy, and which is, in particular, necessary to configure a plug-in in real time in the plug-in manager 210 when the game application unit 100 is initialized.

Further, the utility unit 312 means a plug-in for defining various types of additional functions used in the game application unit 100.

Meanwhile, the multithreading framework may further include a framework factory configured to generate various types of internal objects based on a platform, an event handler configured to process one or more events, a thread manager configured to control one or more threads, a framework interface configured to control the various types of functions of the framework, and a framework implementation unit implemented based on the platform. The external application program may be implemented by receiving the framework interface, so that a desired type of game engine can be configured by adding various types of plug-ins.

Further, the multithreading framework includes a plug-in interface and the job scheduler 202. The plug-in interface can have an added specific plug0in by connecting various types of functions in a plug0in member, if necessary. The job scheduler 202 provides a function of implementing a job which requires parallel processing in a plug-in or an application program. When a unit job which requires parallel processing is provided, the job scheduler 202 processes the parallel processing based thereon.

Next, when a framework is initialized in the multithreading framework supporting dynamic load balancing, which has a configuration as described above, a process of selectively operating in a single thread mode or a multi-thread mode based on the number of cores of a current platform will be described.

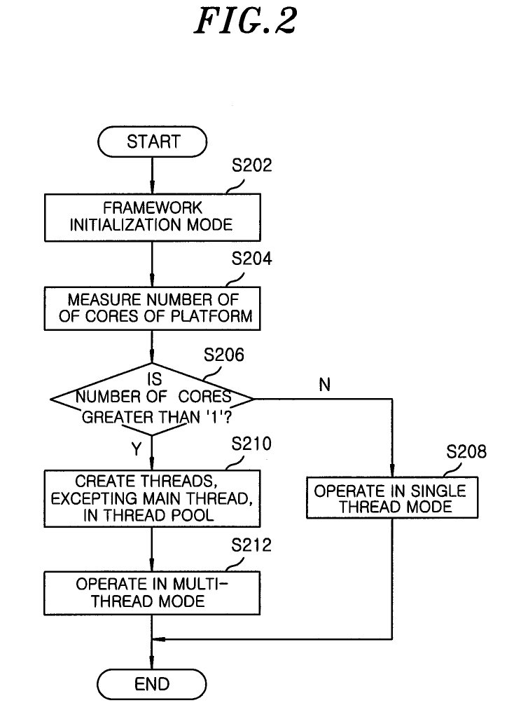

FIG. 2 is a flowchart showing a process of initializing the multithreading framework in accordance with the present invention.

With reference to FIG. 2, in a multithreading framework initialization mode at step S202, the job scheduler 202 measures the number of cores of a current platform when a specific application operates at step S204.

Thereafter, the job scheduler 202 determines whether the measured number of cores of the current platform is greater than ‘1’ at step S206.

If, as the result of the determination at step S206, the measured number of cores of the current platform is ‘1’, and is not greater than ‘1’, a single thread mode operates at step S208. If the measured number of cores of the current platform is greater than ‘1’, the job scheduler 202 creates n−1 threads in a thread pool, excepting a main thread in which a specific application is currently operating, at step S210, and then a multi-thread mode operates at step S212. Here, if the single thread mode operates, that is, if a single core is used for multithreading, performance may be lowered due to the influence of a context switching. In order to minimize the load generated when threads are created and managed, threads may be managed through the thread pool using a method of previously creating threads and recycling the threads whenever a unit job occurs. Further, a number of threads greater than the number of cores of a CPU can be used depending on the characters and status of a processor or an application to which SMT technology, such as HTT, is applied.

Thereafter, a process of performing a single thread mode based on a single core after performing the process of initializing the multithreading framework as described above will be described.

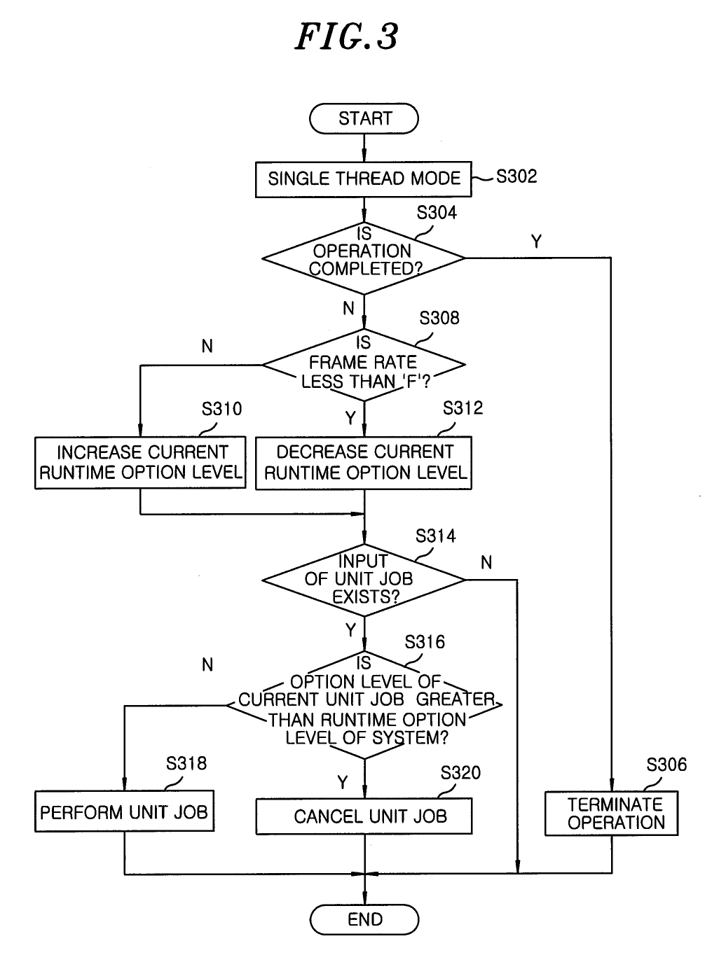

FIG. 3 is a flowchart showing a process of performing the single thread mode of the multithreading framework in accordance with the present invention.

With reference to FIG. 3, in the single thread mode of the multithreading framework at step S302, the job scheduler 202 determines whether a framework's operation termination signal exists at step S304. If the operation termination signal exists, the job scheduler 202 terminates the operation of the framework at step S306. If no operation termination signal exists, the job scheduler 202 determines whether a system frame rate is lower than ‘F’ at step S308. Here, ‘F’ means a frame reference value previously set so as to increase or decrease a runtime option level, and the frame reference value can be set to, for example, 30 frames/second or 60 frames/second.

If, as the result of the determination at step S308, it is determined that the system frame rate is not lower than ‘F’ and the frame rate is maintained at a predetermined level, the job scheduler 202 increases a current runtime option level at step S310. If the system frame rate is lower than ‘F’, the job scheduler 202 decreases the current runtime option level at step S312. Here, the runtime option level means a specific threshold value allocated to a unit job for a specific application and compared with an option level used to determine the order of the corresponding unit job and determine whether to process the unit job.

Thereafter, the job scheduler 202 determines whether the input of a unit job loaded in a job queue exists at step S314. If the input of a unit job exists, the job scheduler 202 compares the option level of the corresponding unit job with the currently increased or decreased runtime option level, and then determines whether the option level of the corresponding current unit job exceeds the runtime option level of a system at step S316.

If, as the result of the determination at step S316, it is determined that the option level of the corresponding unit job does not exceed the runtime option level of the system, the job scheduler 202 executes the corresponding unit job at step S318. If the option level of the current unit job exceeds the runtime option level of the system, the job scheduler 202 cancels the corresponding unit job at step S320.

Therefore, the present invention can increase or decrease a current runtime option level based on the system frame rate in a single thread mode. If the input of a unit job exists, the present invention can execute or cancel the corresponding unit job by comparing the option level of the corresponding unit job with the runtime option level of the system.

Thereafter, in the multi-thread mode of the multithreading framework, a process of performing parallel processing by not only performing the framework's operation termination, determining whether the input of a unit job exists, and storing the input unit job but also checking a job queue, determining whether one or more usable threads exist, and performing job scheduling will be described.

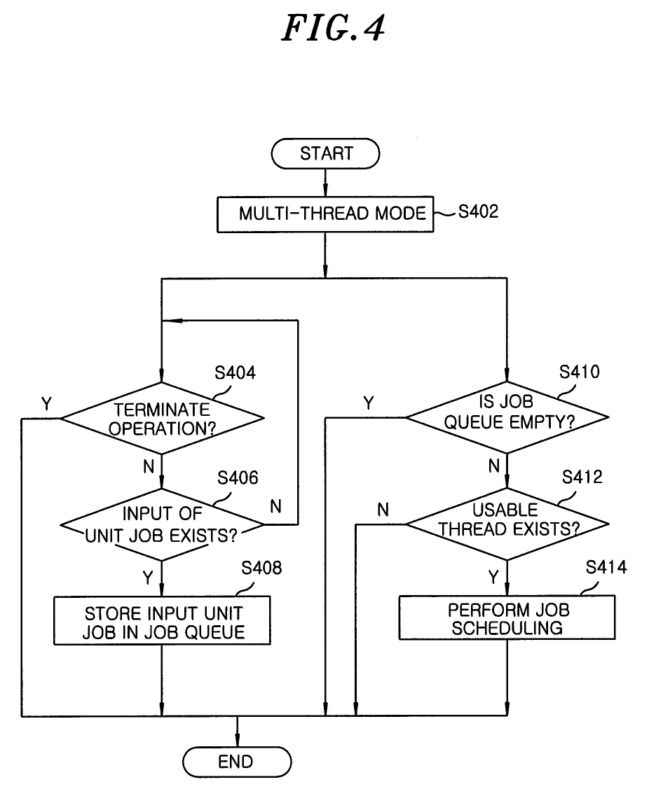

FIG. 4 is a flowchart showing a process of performing the multithreading mode of the multithreading framework in accordance with the present invention.

With reference to FIG. 4, in the multi-thread mode of the multithreading framework at step S402, the job scheduler 202 determines whether a framework's operation termination signal exists at step S404. If no operation termination signal exists, the job scheduler 202 determines whether the input of a unit job exists at step S406. If no input of a unit job exists, the job scheduler 202 performs the step of determining whether the framework's operation termination signal exists at step S404 again. If the input of a unit job exists, the job scheduler 202 stores (loads) the corresponding input unit job in a job queue at step S408.

Meanwhile, the job scheduler 202 not only performs the above-described steps S404 to S408 but also performs the steps S410 to S414, that is, the job scheduler 202 performs parallel processing. Here, the job scheduler 202 determines whether a unit job to be performed exists in a job queue, that is, determines whether the job queue is empty at step S410.

If, as the result of the determination at step S410, it is determined that a unit job to be performed exists in the job queue, the job scheduler 202 determines whether a usable thread (that is, an idle thread) exists in a thread pool at step S412. If a usable thread exists in the thread pool, the job scheduler 202 performs job scheduling using the usable thread (idle thread) at step S414.

Meanwhile, although the present invention has described the case where the multi-thread mode is terminated after the processes for respective steps are completed, as shown in FIG. 4, the multi-thread mode is terminated only when operation is terminated after the operation termination determination step at step S404. In cases other than the above case, the process of the multi-thread mode (that is, the parallel processing process) can be continuously performed.

Therefore, in the multi-thread mode of the multithreading framework, the input of the unit job is determined, the corresponding unit job is stored in the job queue, and at a same time the job queue is checked. If a unit job to be performed exists, whether a usable thread exists is determined, and then job scheduling can be performed on the basis of thereon.

Thereafter, a process of determining the system frame rate in the job scheduling mode of the multithreading framework, performing the increase of an option level, the decrease of an option level, or the increase of the capacity of a thread pool based on the CPU load, extracting a unit job from a job queue, and then executing or canceling the unit job based on the result of comparison of the option level and a runtime option level will be described.

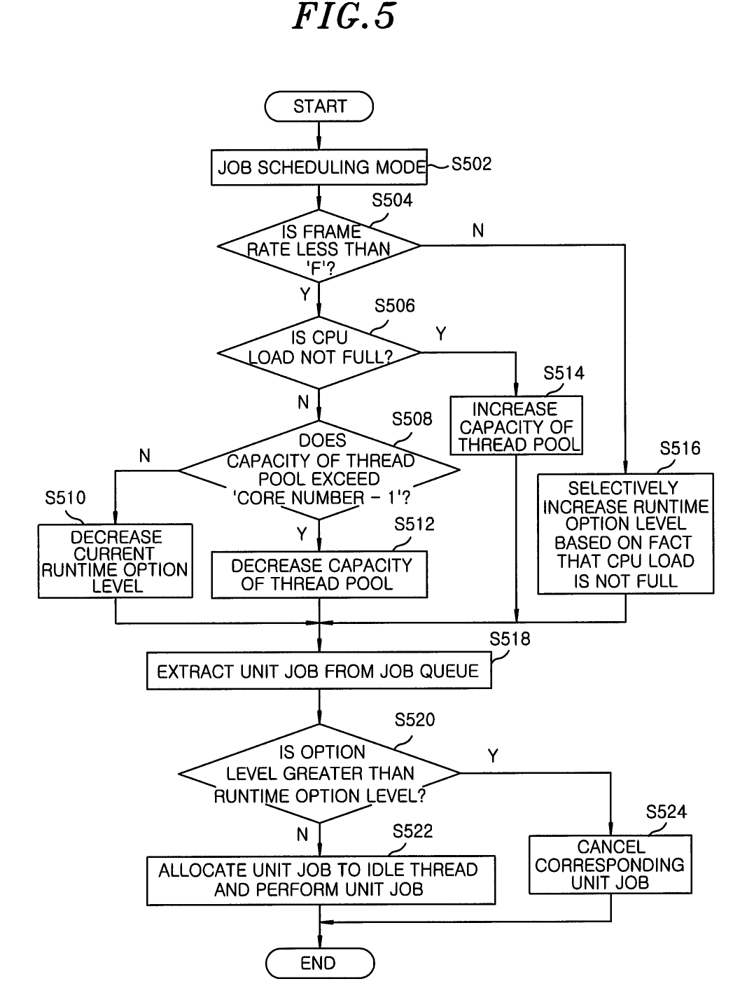

FIG. 5 is a flowchart showing a process of performing the task scheduling mode of the multithreading framework in accordance with the present invention.

With reference to FIG. 5, in the job scheduling mode of the multithreading framework at step S502, the job scheduler 202 determines whether a system frame rate is lower than ‘F’ at step S504. Here, F′ means a frame reference value previously set so as to increase or decrease a runtime option level, and the frame reference value can be set to, for example, 30 frames/second or 60 frames/second.

If, as the result of the determination at step S504, it is determined that the system frame rate is lower than ‘F’, the job scheduler 202 determines whether current CPU load capacity remains at step S506. If no CPU load capacity remains, that is, the CPU (each core in the case of multi-core processors) is utilized 100%, the job scheduler 202 determines whether the capacity of the current thread pool ‘an initially set core number−1 (that is, n−1)’ at step S508.

If, as the result of the determination at step S508, it is determined that the capacity of the current thread pool does not exceed the ‘initially set core number−1’, the job scheduler 202 decreases the runtime option level of a system at step S510. If the capacity of the current thread pool is found to exceed ‘initially set core number−1’, the job scheduler 202 decreases the capacity of the thread pool at step S512. Here, if the capacity of the current thread pool exceeds ‘initially set core number−1’ at step S512, the capacity of the parallel processing of the current system is overused. That is, context switching occurs in the multi-core processor, and unnecessary CPU load is created. At step S510, the number of unit jobs that are executed can be reduced by decreasing the runtime option level. Further, a number of threads greater than the number of cores of a CPU can be used depending on the characters or status of a processor or application to which an SMT, such as an HTT, is applied.

Meanwhile, if, as the result of the determination at step S506, it is determined that the CPU load capacity remains, that is, the CPU (each core in the case of a multi-core processor) is not utilized 100%, the job scheduler 202 increases the capacity of the thread pool at step S514. Here, the number of unit jobs that are executed can be increased by increasing the capacity of the thread pool at step S514.

Further, if, as the result of the determination at step S504, it is determined that the system frame rate is not lower than ‘F’, and the system frame rate is maintained at a predetermined level, the job scheduler 202 checks the CPU load and then selectively increases the current runtime option level only when the CPU load capacity remains at step S516. The increase of the runtime option level enables a complex unit job to be performed.

Thereafter, the job scheduler 202 adjusts the capacity of the thread pool and the runtime option level, as described above, and extracts the corresponding unit job stored (loaded) in the job queue at step S518, and then determines whether the option level of the corresponding unit job exceeds the runtime option level of the system at step S520.

If, as the result of the determination at step S520, the option level of the corresponding unit job is determined not to exceed the runtime option level of the system, the job scheduler 202 allocates the corresponding unit job to an idle thread and then executes the corresponding unit job at step S522. If the option level of the corresponding unit job is determined to exceed the runtime option level of the system, the job scheduler 202 cancels the corresponding unit job at step S524.

Therefore, in the job scheduling mode of the multithreading framework, the runtime option level and capacity of the thread pool of the system can be adjusted based on the system frame rate, the CPU load, and the capacity of the thread pool, and the corresponding unit job can be performed or canceled by extracting the corresponding unit job and then comparing the option level thereof with the runtime option level.

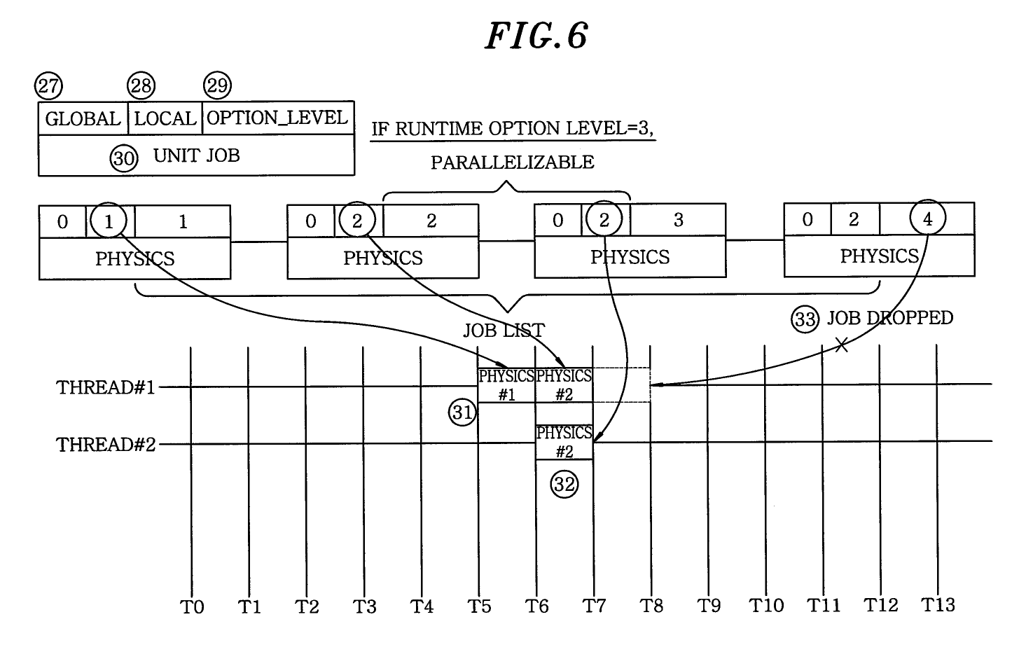

FIG. 6 is a view showing the configuration of the unit of a task and task scheduling in the multithreading framework in accordance with the present invention.

With reference to FIG. 6, a unit job is broadly configured to have four parts. Part ‘Global’ 27 receives a unique number assigned from the job scheduler for each task module. Part ‘Local’ 28 defines priority between unit jobs using a serial number freely assigned in a corresponding module. Part ‘Option_Level’ (that is, an option level) 29 indicates the complexity of a unit job, and a developer can freely set the complexity at a game application program development step. Here, Part ‘Unit Job’ 30 defines the job to be performed, and corresponds to the thread callback function of the prior art thread programming.

A method of performing job scheduling on a unit job will be described. First, the job scheduler 202 determines whether a job stored in a job list (a job queue) can be fetched using a global serial number (Global) and a local serial number (Local). Thereafter, only when the option level (Option_Level) of a unit job is lower than the runtime option level of a current system, the unit job (Unit Job) is allocated to a real thread and is then performed. As shown in FIG. 6, it is assumed that the global serial number is ‘0’, so that all modules perform physical jobs (Physics), and the runtime option level of a system is ‘3’. In the case in which each of the unit jobs is expressed as {global, local, option level}, the unit jobs are stored in the order of {0,1,1}-{0,2,2}-{0,2,3}-{0,3,4} in the job list. In the case of the unit job {0,1,1}, since there is no previous job and the option level of the corresponding unit job is smaller than ‘3’, which is the runtime option level, the unit job {0,1,1} can be allocated to an idle thread (Thread#1) without limitation (Refer to reference number 31). In the case of the unit job {0,2,2}, the unit job {0,2,2} can be allocated to an idle thread after the unit job {0,1,1} is completed due to the local serial number. Since the option level of the unit job is smaller than ‘3, ’ which is the runtime option level, the unit job {0,2,2} is allocated to the idle thread (Thread#1) at the time point ‘t6’ at which the unit job {0,0,1} is completed. In the case of the unit job {0,2,3}, the unit job {0,2,3} has the same local serial number as the unit job {0,2,2}. Since the option level of the unit job {0,2,3} does not exceed ‘3’, which is the runtime option level, the unit job {0,2,3} can be allocated to an idle thread (Thread#2) simultaneously. Here, the unit job {0,2,2} and the unit job {0,2,3} are simultaneously performed (Refer to reference number 32).

Meanwhile, although the unit job {0,3,4} can be allocated at a time point ‘t7’ at which the unit job {0,2,2} and the unit job {0,2,3} are completed, the unit job {0,3,4} is canceled since the option level of the unit job {0,3,4} is ‘4’, that is, the option level of the unit job {0,3,4} exceeds ‘3’, which is the runtime option level (reference number 33).

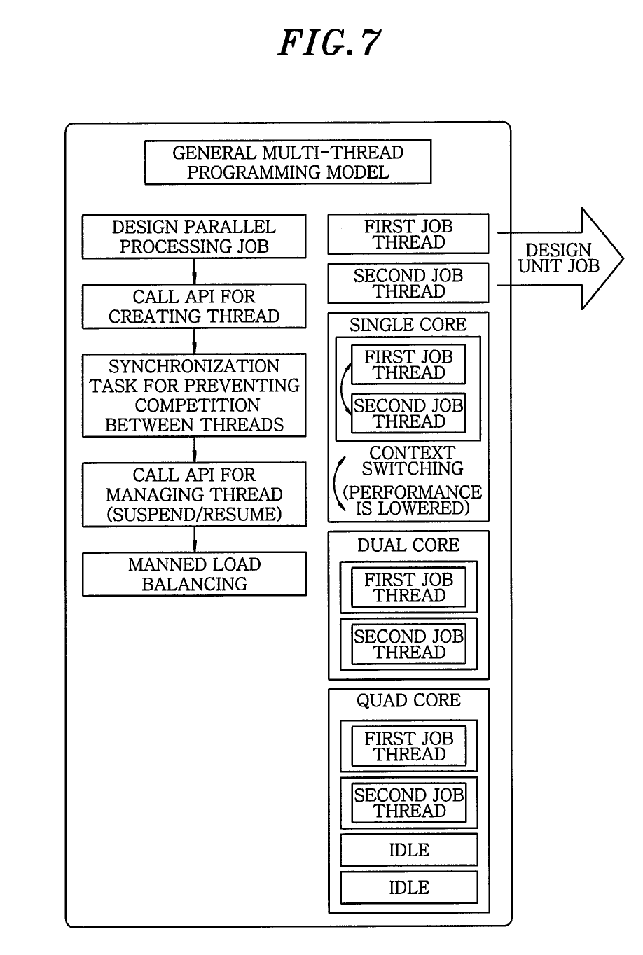

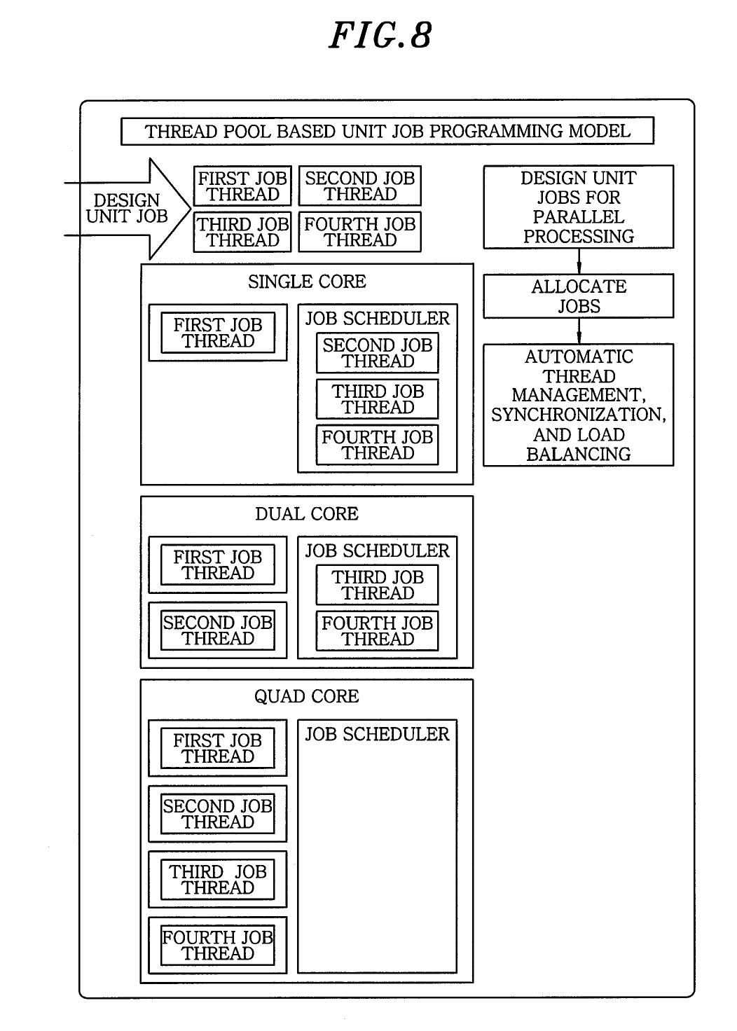

FIGS. 7 and 8 are a view showing the comparison of the multithreading framework in accordance with the present invention.

With reference to FIGS. 7 and 8, in a conventional multithread programming model, tasks, such as the design of a parallel processing job, the call of an Application Program Interface (API) for creating threads, a synchronization task for preventing competition between threads, the call of API for managing threads, and manned load balancing, must be performed. Since the general multithread programming model is optimized for a specific platform, the performance thereof is lowered on other platforms.

Meanwhile, the unit job programming model based on a thread pool and proposed in the present invention performs the design of parallel processing unit job, job allocation, automatic thread management, synchronization, and load balancing. In particular, after jobs are allocated, management for the jobs and threads is automatically realized. In the case in which the job scheduler proposed in the present invention is used, automatic load balancing is possible, so that the job scheduler can be simultaneously applied to a single core and multi-cores and optimized performance can be expected on each of platforms. The multithreading framework can be expected to display optimized operation performance regardless of the number of cores of a platform, and dynamic load balancing is implemented therein by controlling the thread pool and option level.

The present invention implements a multithreading framework including a job scheduler for performing parallel processing by redefining the processing order of unit jobs transmitted from a predetermined application based on unit job information included in each of the unit jobs, and transmitting the unit jobs to a thread pool based on the redefined processing order. In this way, complex multithread programming tasks can be simply performed, a programming model can be applied in a consistent manner regardless of the number of cores, and a dynamic load balancing function can be provided by using the number of thread pools, the option level of a unit job, and a runtime option level.

Although the invention has been shown and described with respect to the preferred embodiments, the present invention is not limited thereto. Further, it will be understood by those skilled in the art that various changes and modifications may be made without departing from the spirit and scope of the invention as defined in the following claims.

What is claimed is:

1. A multithreading framework supporting dynamic load balancing, the multithreading framework being used to perform multi-thread programming, the multithreading framework comprising:
a job scheduler for performing parallel processing by redefining a processing order of one or more unit jobs, transmitted from a predetermined application, based on unit job information included in the respective unit jobs, and transmitting the unit jobs to a thread pool based on the redefined processing order;
a device enumerator for detecting a device in which the predetermined application is executed and defining resources used inside the application;
a resource manager for managing the resources related to the predetermined application executed using the job scheduler or the device enumerator; and
a plug-in manager for managing a plurality of modules which performs various types of functions related to the predetermined application in a plug-in manner, and providing such plug-in modules to the job scheduler.

2. The multithreading framework of claim 1, further comprising a memory manager for performing memory management in order to prevent memory-related problems, including memory fragmentation of the multithreading framework.

3. The multithreading framework of claim 1, wherein the predetermined application is used in a state of being overridden in a virtual function form in the multithreading framework by using written game code, and is configured to perform functions related to initialization for various types of applications, update of input values, processing of the input values, update of status and termination, construct one or more desired unit jobs based thereon and provide the unit jobs to the job scheduler.

4. The multithreading framework of claim 3, wherein the predetermined application comprises:
an initialization unit for performing an initialization function for various types of applications which operate based on the multithreading framework;
a game loop unit for updating an input value for each loop of the predetermined application, processing the updated input value based on the predetermined application, and performing update of status related to a game; and
a termination unit for, when the predetermined application is terminated, processing a termination process including cleaning garbage collection of memory and terminating network connection.

5. The multithreading framework of claim 4, wherein the game loop unit comprises:
an update input unit for updating the input values, including an input by a user and an input over a network at each loop of the predetermined application;
a process input unit for processing the input values, collected by the update input unit, based on the application; and
a game update unit for performing update of the status related to the game, including a game animation, a physical simulation, artificial intelligence update, and screen update for the predetermined application.

6. The multithreading framework of claim 1, wherein the job scheduler performs a single thread mode or a multi-thread mode based on a number of cores of a platform.

7. The multithreading framework of claim 6, wherein the job scheduler performs or cancels one of the unit jobs in the single thread mode by increasing or decreasing a runtime option level based on a predetermined frame rate, and comparing an option level of the corresponding unit job with the increased or decreased runtime option level.

8. The multithreading framework of claim 6, wherein the job scheduler performs parallel processing in the multi-thread mode by performing checking whether the multithreading framework's operation termination signal exists, checking of validity of the unit job and storage of the input unit job while performing checking of a job queue, determination of whether one or more usable threads exist and job scheduling.

9. The multithreading framework of claim 8, wherein the job scheduling is performed by increasing or decreasing capacity of the thread pool or increasing or decreasing the runtime option level based on a preset frame rate and Central Processing Unit (CPU) load, and then performing or canceling the unit job based on a result of comparing the option level and the runtime option level.

10. The multithreading framework of claim 9, wherein the unit job comprises a global serial number, a local serial number, the option level, and defined job information.

11. The multithreading framework of claim 1, wherein the plug-in module constructs a specific engine by implementing and allocating functions, used for the unit jobs, as a respective module.

12. The multithreading framework of claim 11, wherein the plug-in module comprises:
a plug-in for performing a function of rendering a polygon on a screen using a graphic library, including DirectX or OpenGL, for the predetermined application;
a plug-in for performing a function of taking charge of physical simulation so as to perform realistic expression for the predetermined application;
a plug-in for performing automatic control of a Non-Player Character (NPC) used in the predetermined application;
a plug-in for performing a function of taking charge of providing one or more interfaces which enable configuration of the predetermined application to be modified from an outside without changing source code, and supporting various types of interfaces so as to use script languages; and
a plug-in for defining additional functions for the predetermined application.

13. A multithread processing method using a multithreading framework supporting dynamic load balancing, the multithreading framework being used to perform multi-thread programming, the multithread processing method comprising:
switching between a single thread mode and a multi-thread mode based on a number of cores of a platform of the multithreading framework;
in a case of the single thread mode, increasing or decreasing a runtime option level based on a preset frame rate, and performing or canceling a unit job based on a result of comparing an option level of the corresponding unit job with the increased or decreased runtime option level; and
in a case of the multi-thread mode, performing checking whether the multithreading framework's operation termination signal exists, checking whether input of a unit job exists, and storing the input unit job while checking a job queue, determination whether one or more usable threads exist, and performing job scheduling.

14. The multithread processing method of claim 13, further comprising, after the step of, in a case of the multi-thread mode, performing checking, increasing or decreasing a capacity of a thread pool based on the preset frame rate and CPU load, or increasing or decreasing the runtime option level, and performing or canceling the unit job based on the result of comparing the option level with the runtime option level.

15. The multithread processing method of claim 13, wherein the step of switching comprises:
if a predetermined application operates in an initialization mode of the multithreading framework, measuring a number of cores of a current platform;
determining whether the measured number of cores of the current platform is greater than ‘1’;
if the measured number of cores of the current platform is ‘1’, operating in the single thread mode; and
if the measured number of cores of the current platform is greater than ‘1’, creating n−1 threads, excepting a main thread in which the predetermined application is being operated, in the thread pool, and then operating in the multi-thread mode, wherein n is the measured number of cores of the current platfrom.

16. The multithread processing method of claim 13, wherein the step of increasing or decreasing the runtime option level, in the case of the single thread mode, comprises:
increasing or decreasing the runtime option level based on the preset frame rate, and determining whether input of a unit job exists in a job queue of the multithreading framework;
if the input of a unit job exists, comparing the option level of the corresponding unit job and the increased or decreased runtime option level; and
if the option level of the unit job does not exceed the runtime option level, performing the unit job, and, if the option level of the unit job exceeds the runtime option level, canceling the unit job.

17. The multithread processing method of claim 16, wherein the step of increasing or decreasing the runtime option level, in the case of the single thread mode, comprises:
determining whether the frame rate of the multithreading framework is lower than the preset frame rate;
if the frame rate is not lower than the preset frame rate and is maintained at a predetermined level, increasing the runtime option level; and
if the frame rate is lower than the preset frame rate, decreasing the runtime option level.

18. The multithread processing method of claim 13, wherein the step of performing checking, in a case of the multi-thread mode, comprises:
determining whether a multithreading framework's operation termination signal exists, and, if no operation termination signal exists, determining whether input of the unit job exists;
if no input of the unit job exists, determining whether the operation termination signal exists again, and, if the input of the unit job exists, storing the unit job in the job queue;
determining whether a unit job to be performed exists in the job queue while performing the step of determining whether the multithreading framework's operation termination signal exists and the step of if no input of the unit job exists, determining whether the operation termination signal exists again;
if a unit job to be performed exists in the job queue, determining whether a usable idle thread exists in the thread pool; and
if a usable idle thread exists in the thread pool, performing job scheduling using the idle thread.

19. The multithread processing method of claim 14, wherein the step of increasing or decreasing the capacity of the thread pool comprises:
if the frame rate of the multithreading framework is lower than a preset frame rate, determining whether CPU load capacity of the multithreading framework has idle resource;
if the CPU load capacity does not have idle resource, determining whether capacity of the thread pool exceeds ‘an initially set core number−1’;
if the capacity of the thread pool does not exceed the ‘initially set core number−1’, decreasing the runtime option level;
if the capacity of the thread pool exceeds the ‘initially set core number−1’, decreasing the capacity of the thread pool;
if the CPU load capacity has idle resource, increasing the capacity of the thread pool;
if the frame rate is not lower than the preset frame rate and is maintained at a predetermined level, selectively increasing the runtime option level only when the CPU load capacity has idle resource; and
performing or canceling the unit job based on a result of comparing the option level with the increased or decreased runtime option level.

20. The multithread processing method of claim 19, wherein the step of performing of canceling the unit job comprises:
adjusting the capacity of the thread pool and the runtime option level, and then extracting the unit job stored in the job queue;
determining whether the option level of the extracted unit job exceeds the runtime option level;
if the option level of the extracted unit job does not exceed the runtime option level, allocating the unit job to an idle thread so that the unit job is performed; and
if the option level of the extracted unit job exceeds the runtime option level, canceling the unit job.
